(19) United States
(12) Patent Application Publication
(10) Pub. No.: US 2002/0195407 A1
(43) Pub. Date: Dec. 26, 2002

(54) Purfication media

(76) Inventor: Ehud Levy, Roswell, GA (US)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 09/772,542

(22) Filed: Jan. 30, 2001

Related U.S. Application Data
(63) Continuation-in-part of application No. 09/560,824, filed on Apr. 28, 2000, now abandoned.
(63) Continuation of application No. 08/819,999, filed on Mar. 18, 1997, now Pat. No. 6,241,893.
(60) Provisional application No. 60/259,523, filed on Jan. 3, 2001.

(51) Int. Cl. C02F 1/00

(52) U.S. Cl. 210/767

(57) ABSTRACT

The invention relates to mixed purification media, containing two or more of zirconia, carbon, aluminosilicate, silica gel, and alumina, as well as to purification media containing zirconia.

This application claims benefit of the filing date of provisional U.S. Application Serial No. 60/259,523, filed Jan. 3, 2001. This application is a continuation-in-part of Ser. No. 09/560,824, filed Apr. 28, 2000 and of Ser. No. 08/819,999, filed Mar. 18, 1998. The entire contents of each application is hereby incorporated by reference.

### FIELD OF THE INVENTION

The invention relates to purification media which utilize a mixture of filtration media. More particularly, it relates to such filters wherein the filtration media is composed of at least two of the following substances: carbon, aluminosilicate, silica gel, alumina and zirconia. Additionally, the invention relates to purification media containing zirconia.

### BACKGROUND OF THE INVENTION

The chemistry of potable drinking water varies significantly from location to location throughout the United States. Many municipal drinking water plants are delivering drinking water from wall and ground water that contains arsenic, lead, VOC (Volatile Organic Chemicals) such as chloroform, mercury and other contaminates. Arsenic and VOC have also been found in drinking water in many other countries. Arsenic species are being used or have been used in the manufacture of medicine and cosmetics among other things, and have been used as agricultural insecticides. They have also been used as desiccants, in rodenticides and in herbicides. Arsenic contaminates are primarily found as an arsenate or an arsenite in drinking water. Chloroform, as a member of the trihalomethanes family, is often a major byproduct of chlorination-disinfection processes used in water treatment. These contaminates are considered health hazards which can cause cancer, skin discoloration, liver disease and a host of other health problems.

To reduce arsenic from drinking water, municipal water plants use different techniques such as redox, adsorption and precipitation. The most common media for adsorption used today is alumina together with weak acid ion exchange resins. Alumina works well to reduce arsenic levels from about one part per million to about five parts per billion. However, alumina media for such purposes is usually used in small applications such as point-of-use water filters, and such use is limited. This is due primarily to the poor kinetics of such filters. Ion exchange resins suffer the same limitation. Another technique employed to remove arsenic is reverse osmosis which is very effective. However, it is an expensive treatment which causes a considerable amount of water to be wasted. In some cases this technique has experienced difficulty due to a change in the oxidation state of the arsenic contaminate from an arsenate to an arsenite. Municipalities have been struggling for a number of years, using different techniques of oxidizing arsenic for removal by their water plants. The cost for doing so in capital investment is extremely high and at present over six hundred municipalities continue to experience substantial difficulty in their efforts to reduce arsenic content from drinking water. The cost of doing so is for many small municipalities prohibitive due to the complexity of existing methods which are adapted from large scale plants. Moreover, many proposed treatments adversely affect the taste and color of the water and may produce unknown by-products.

### SUMMARY OF THE INVENTION

It has been found that the utilization of zirconia in small point-of-use filters for drinking water is an efficient method of reducing arsenic from two hundred parts per billion to one part per billion without, at the same time, adversely affecting the pH and hardness of the water. The kinetics of the zirconia is ten to twenty times better than ion exchange methods. Moreover, by mixing zirconia with other known filtration media in selected proportions, an excellent point-of-use filtration media may be provided to remove not only arsenic, but other contaminates from drinking water. Specifically, the media may be composed of zirconia along with carbon of carbon block, aluminosilicate, silica gel (60 Angstroms) and alumina (acid washed) to obtain a marked reduction not only of the arsenic content, but also of inorganic contaminants such as heavy metals, and organic contaminates, such as chloroform, in drinking water. Zirconia and alumina (acid washed) work well in a two-stage system for purification of drinking water. The zirconia in powdered form at 20-80 μm and in granular form of 8×100 mesh without other media composition, works well in removing arsenic from drinking water in applications from 0.13 gpm and up. Zirconia can be powdered or granular, and may be combined with activated carbon, which can be in the form of a block with an organic binder or in powdered or granular form, to form an effective purification media. The materials of the invention are particularly effective for purifying water to make it potable.

### BRIEF DESCRIPTION OF THE DRAWINGS

Other objects, adaptabilities and capabilities appear as the description progresses, reference being made to the accompanying drawings wherein

FIG. 1 is a graph illustrating the pore structure of filtration media composed of activated carbon produced from coconut shells, and

FIG. 2 is a graph illustrating the pore structure of filtration media composed of silica gel (60 Angstroms).

### DETAILED DESCRIPTION OF THE PREFERRED EMBODIMENTS

Various types of materials which are used to remove inorganic contaminates from drinking water comprise alumina, zeolite, silica gel, and a variety of metal oxides and synthetic polymers. In general, the adsorption capacity of most of these media types is more limited than desirable. In testing a concentrated solution of arsenic in a 50 milliliter glass column with a stock solution of 200-500 parts per million arsenate, it was ascertained that the total capacity for alumina adsorption was 16 grams per cubic foot of the media. For silica gel, it was 2 grams per cubic foot. For a metal oxide which was tested, it was 0.5 grams per cubic foot. In contrast, with zirconia as a filtration media, the adsorption capacity was 80 grams per cubic foot. As a result, filters were produced composed of mixtures of 5% to 15% zirconia, 70% carbon and 15% to 25% organic binder, whereby a 10 inch by 2.5 inch cartridge (interior height×diameter) provided 49 cubic inches of filtration media. With a flow rate of about one gpm with an average of 0.2 ppm influent arsenate at a pH of 7.6, the arsenic reduction for the first 1,000 gallons was below one ppb as measured by a Perkin Elmer atomic adsorption spectrometer.

The same experiments were conducted utilizing alumina instead of zirconia. Here, the arsenic level was reduced to one ppb for the first 65 gallons. After 100 gallons, the efficiency was a low 26%. At 300 gallons there was no efficiency at all. The kinetics of the zirconia was extremely high. It was thought that the potential for removing arsenic anions by zirconia was fifty times higher than for alumina with the same filtration configuration. Calculating the removal of arsenic on the basis of 20-μm zirconia, it was estimated that the potential capacity of one gram of zirconia to remove arsenic is up to about 400 milligrams. The capacity to remove chloroform was found to be about 8,000 μg/g. The capacity to remove lead is about 600 μg/g. In contrast, the capacity of one gram of alumina to remove arsenic is around 20 mg/g. Its capacity to remove chloroform is about 500 μg/g. Its capacity to remove lead is about 200 μg/g. Also with alumina, when the flow rate increases, arsenic adsorption efficiency is reduced by approximately 46%.

By employing gamma alumina with acidic surfaces produced as set forth in Levy U.S. Pat. No. 5,133,871 as a prefilter, the second filter being zirconia, the kinetics were improved by about twenty times, and the capacity of the filter was improved by about thirty times. It was considered that the alumina media in combination with the zirconia media produced positive/negative charges which apparently cause the arsenic anions to be attracted more rapidly to the zirconia surface. Using these filters separately in conditions of water containing arsenic to an extreme extent, the alumina reduced the arsenic from 200 to 60 parts per billion in 200 gallons at a flow rate of one gallon per minute. The zirconia medium, which is here mixed with carbon, reduced the arsenic from 200 to 30 parts per billion in 300 gallons at a flow rate of one gallon per minute. However, when combined with the alumina followed by the zirconia in series in a 110 cubic inch filter, the arsenic was reduced from 200 to one part per billion for at least 3,000 and up to 6,000 gallons at a flow rate of one gallon per minute with no breakthrough.

When the zirconia was tested in a static column with approximately 100 grams of zirconia, the arsenic level was reduced from 600 parts per million to one part per billion with a flow rate of one milliliter per minute. This is an extremely high efficiency rate at a very low flow rate. When the flow rate was increased, the efficiency was reduced. However, by adding alumina as a filtration media prior to the zirconia, the kinetics were improved in spite of the increased flow rate through the media.

By combining the zirconia with carbon block, filters with extremely small ratings were produced of 25% zirconia, 60% carbon, and the balance organic binder. The filters produced were 7 cubic inches. With a flow rate of one-half gallon per minute, the arsenic was reduced from 120 parts per billion to one part per billion for 400 gallons.

It is known that arsenic can be oxidized from arsenate to arsenite states in the presence of a high concentration of chlorine. It has been found that zirconia as a filtration media removes such arsenic species quite rapidly. The pore size of the zirconia may vary from 5 to 500 Angstroms. It is believed that the pore diameter effects the capacity of the filter which depends on the micron rating. In a block composition, it has been ascertained that the zirconia in the 5 Angstrom to 60 Angstrom range provides the highest efficiency for arsenic anion production. However, in making zirconia pellets or coated zirconia or alumina, 20×40 mesh, for use in large commercial applications, 60 Angstrom to 200 Angstrom pore sizes have been found to work satisfactorily. Zirconia can be regenerated for commercial applications with 5% sodium hydroxide and is capable of operating in a pH up to 14 without adversely effecting the zirconia structure. Zirconia with a particle size of 5 to 100 μm can be compressed at relatively low pressures to form a solid block, using a pressure up to a maximum of 200 psi. With 0.5 to 3 μm zirconia, a maximum of 200 psi of pressure may be similarly used to form the zirconia filtration media. These relatively low pressures permit the production of a cost effective product with either media or with mixed media.

The voracities of surface activities of zirconia in the foregoing tests were determined by nitrogen adsorption and mercury intrusion tests to map the pores in their structures in the zirconia media. In experiments of 15 different zirconia materials, it was discovered that the capacity of the zirconia for arsenic and chloroform reduction varied depending on the pore diameter of the zirconia. When the pore diameter commences to exceed 100 Angstroms, there is a drop of about 40% in the adsorption for both the arsenic and the chloroform. Also it was determined in further experiments that zirconia is quite effective in the reduction of fluorides in the drinking water.

Also, mixtures of aluminosilicates having pore diameters in the range of 60 Angstroms to 100 Angstroms, with approximately 5% to 10% zirconia, 65% carbon, and organic binder were tested. The aluminosilicate used in these experiments were amorphous compositions as disclosed in the inventor' a co-pending application Ser. No. 08/819,999 filed Mar. 18, 1997. The results were reductions from drinking water of lead cations, arsenic anions, mercury cations and VOC, each to one part per billion or less. Moreover, each of the blends which were mixed contributed to improve the performance of the other filtration media. The mixes permitted flow rates of 0.5 to 10 gallons per minute. The resulting filtration media exhibited high stability and no breakthroughs occurred for the life of the filters.

Zirconia, per se, can be used in the form of a ceramic candle which is composed of powdered zirconia molded with organic wax or high temperature binders. As such, it can be formed to any desired shape or diameter depending, of course, upon the flow rate and other requirements of the application.

Particle distribution has been found to be an important parameter for achieving high capacity. It is preferred to maintain a narrow cut such as 5-40 μm for a small rated filter which is about 7 cubic inches in volume.

Molded blocks containing activated carbon and silica gel (60 Angstroms) provide an improvement of about 200% in the reduction of chloroform from drinking water and waste water. Just 5% to 10% of silica gel (60 Angstroms) improves chloroform reduction by four to one when compared to activated carbon alone. It is considered that the silica gel (60 Angstroms) assists the carbon to adsorb the chloroform four times more rapidly than would otherwise occur. Also the silica gel (60 Angstroms), per se, removes chloroform with a capacity of 650 mg/g. Its kinetics are much faster than carbon and its pore structure is more uniform which permits the liquid to pass through without channeling. In testing a 49 cubic inch filter with coconut shell carbon block, a reduction of 300 parts per billion to one part per billion for 500 gallons at a flow rate of one gallon per minute was obtained with no breakthrough. At 600 gallons, there was a 70 parts per billion breakthrough. In testing a 49 cubic inch filter with a mixture of coconut shell and silica gel (60 Angstroms) where the silica gel (60 Angstroms) is about 10% of the mixture, a reduction of 300 parts per billion to one part per billion for 1,200 gallons was obtained without breakthrough.

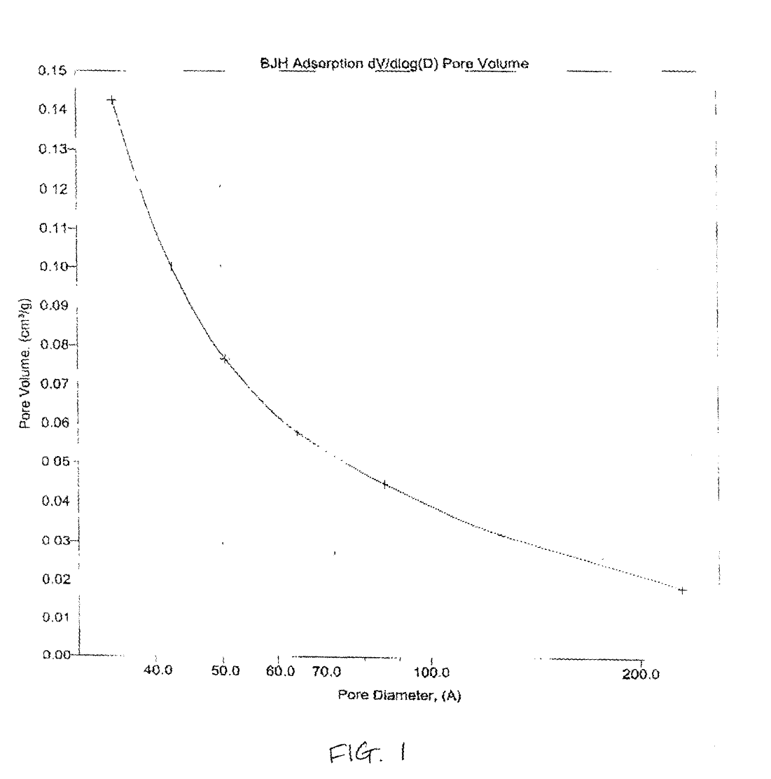

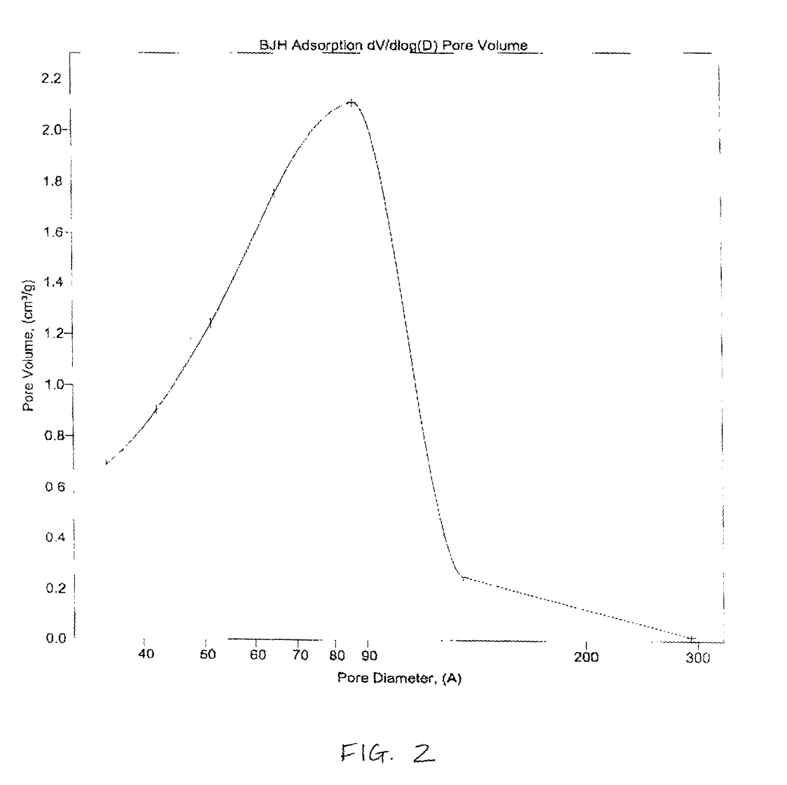

Granular activated carbon and powder carbons have been long known to remove organic contaminates from water. However, activated carbon used for such purposes has been produced from a variety of natural materials, such as carbon shells, peanut shells, peach pits and wood. As a result, the pore distribution has not been uniform, and this non-uniformity carries over to water treatment. In practice, a variation of 72% in filtration characteristics between filters made from different batches of coconut shell can be observed in test runs of 500 gallons. Nevertheless, it has been ascertained that by the addition of 10% to 15% silica gel (60 Angstroms), the performance attained amounts to almost 99.8% consistently. This is considered to be primarily due to the pore structure of silica gel (60 Angstroms). Attention is invited to FIGS. 1 and 2. Here, a pore volume 0.79 milliliters per gram discloses two peaks whereby the pore structure of the silica gel (60 Angstroms) is five times larger than the pore structure of the coconut shell carbon. Inasmuch as the silica gel (60 Angstroms) is amorphous, water molecules can transit the silica gel (60 Angstroms) much more rapidly than the granular carbon.

If zirconia is mixed with silica gal (60 Angstroms) which is mixed with carbon as described above, a further improvement in performance results. Inasmuch as the zirconia and the silica gel (60 Angstroms) remove a substantial amount of the chloroform, mixing of the two quadruples performance of the filter in this respect. Carbon used by the filtration industry to remove organics is usually manufactured from coconut shells produced in a non-controlled environment wherein there is a large variation in the performance of the coconut shell as a filtration media in a compressed carbon block. Zirconia, however, overcomes such problems and assists in providing a uniform adsorption capacity. Drinking waters in the United states generally have a pH range of 6.5 to 10. Zirconia has been found not to migrate in a wide range of pH and pH does not reduce its efficiency. Alumina reduces arsenic quite efficiently at a pH range of 6.5 to 7.5. However, alumina loses about 50% to 60% efficiency when the pH increases to 8.5 or higher.

Alumina is also pH dependent insofar as its capacity is concerned. At a pH of 6.5, the capacity is 20 gallons per cubic foot of filtration media. But when the pH is increased to 8.5, that capacity is reduced to as low as 6.7 gallons per cubic foot of media.

The combination of zirconia and silica gel (60 Angstroms) provide a superior ability to adsorb heavy metals and organic compounds. This is thought to be due to the enhanced surface, chemical properties and pore distribution of the zirconia and silica gel (60 Angstroms). The mixed particles increase the kinetics by five times compared to carbon, and by twenty times compared to alumina. The mixed media has an ability to reduce contamination by heavy metals and organic contaminants to the low one part per billion. The large pore distribution of silica gel (60 angstroms) and the aluminosilicate allows large molecules of around 20 Angstroms in diameter to enter the pore structure of the aluminosilicate and silica gel (60 Angstroms) to almost 25% to 30% of the total body weight of the media. This means that every gram of the media has a 250 to 300 mg/g capacity to remove heavy metals. For organic substances with molecular diameters of about 5 Angstroms, the capacity increases to the neighborhood of about 650 mg/g. The absorption of heavy metals and organic contaminants is affected by water temperature if carbon block, per se, is used. In mixed media of aluminosilicate, zirconia and silica gel (60 Angstrom) no change in adsorption capacities have been found in a temperature range of 36° F. to 100° F.

In experiments with the use of activated carbon, with the filtration media, per se, having pore diameters or 10 Angstroms, 30 Angstroms and 100 Angstroms, no improvement was observed in VOC reduction or kinetic capacity. Thus for small drinking water filters for approximately 50 cubic centimeters, the kinetics for organic reduction at low flow rates of 0.5 gallons per minute is extremely poor. With the use of mixed media as described above, under such circumstances, the organic and heavy metal removal improved by a factor of four. For aesthetic and cost reasons, small filters are increasingly in demand in the marketplace. Therefore, high kinetics is an important characteristic to improve the performance of small filters. Activated carbon unfortunately has a huge variation in its performance in small filters. The present invention effectively overcomes this problem. It has also been found by use or the present invention, chlorinated organic compounds such as TCE, THM and others are prevented from breakthroughs at very high flow rates for four to five times longer than other compositions, particularly activated carbon, per se.

Percentages set forth herein, including in the claims, are by weight.

Although I have disclosed preferred embodiments of my invention, it is to be understood that it is capable of other adaptations and modifications within the scope of the appended claims.

Having thus disclosed my invention, what I claim as new and desire to secure by Letters Patent of the United States of America is:

1. A filtration media for drinking water which is composed of 5% to 15t zirconia, 60% to 80% activated carbon, and 15t to 25t binder material.

2. A filtration media in accordance with claim 1, wherein the carbon content is about 70%.

3. A filtration media in accordance with claim 1, which in composed of about 10% zirconia, about 70% activated carbon, and the balance of binder material.

4. A filtration media for a small filter wherein the media occupies a space less than about 20 cubic inches and wherein the filtration media is composed of 15% to 25% zirconia, 45% to 60%, activated carbon, and the balance of binder material.

5. A filtration media in accordance with claim 4, wherein the zirconia content is about 20%.

6. A filtration media in accordance with claim 4, wherein the zirconia content is about 25%t and the carbon content is about 60%.

7. A filtration media for the filtration of drinking water which is composed of: amorphous aluminosilicate material wherein the major portion of its pores have diameters in the range of 60 Angstroms to 10o Angstroms, 5% to 10%: activated carbon, 60% to 70%: zirconia, 53 to 15%: and a binder of at least 15%.

8. A filtration media in accordance with claim 7, wherein the aluminosilicate content is about 10%, and the activated carbon content is about 65%.

9. A filtration media in accordance with claim 7, wherein the zirconia content is about lot.

10. A filtration media for drinking water which is composed of zirconia of about 4% to 15%, activated carbon of about 65%, alumina of about 5% to 15% and a balance of at least lot binder material.

11. A filtration media in accordance with claim 10, wherein the content of said zirconia is about 10%.

12. A filtration media in accordance with claim 10, wherein said alumina content is about lot.

13. A filtration media for drinking water which is composed of silica gel (60 Angstroms) of about 5% to 10%, activated carbon of about 70% to 80%, and binder material of a minimum of about 15%.

14. A filtration media in accordance with claim 13, wherein the content of said silica gel (60 Angstroms) is about 10% and the content of said activated carbon is about 75%.

15. A filtration media for drinking water which is composed of silica gel (60 Angstroms) of about 5% to 10%, zirconia of about 5% to 15%, activated carbon of about 60% to 70%, and binder material of not less than about 10%.

16. A filtration material in accordance with claim 15, wherein the content of said zirconia is about 10%.

17. A filtration media in accordance with claim 15, wherein the content of said activated carbon is about 65%.

18. A filtration media for drinking water which is composed of silica gal (60 Angstroms) 50% to 70%, zirconia of about 15% to 25%, and binder material of about 15% to 25%.

19. A filter material in accordance with claim 18, wherein the content of said silica gal (60 Angstroms) is about 60%.

20. A filtration media in accordance with claim 18, wherein the content of said zirconia is about 15%.

21. A filtration media in accordance with claim 18, wherein the content of said silica gel (60 Angstroms) is about 60%.

22. A filtration media for drinking water which is composed of aluminosilicate of about 5% to 15%, zirconia of about 5% to 15%, silica gal (60 Angstroms) or about 5% to 10%, activated carbon of about 50% to 70% and binder material of 15% to 25%.

23. A filtration media in accordance with claim 22, wherein said activated carbon content is about 60%.

24. A filtration media in accordance with claim 22, wherein said zirconia content is about 5%.

25. The use of zirconia as a filtration media to remove fluorides from drinking water.

26. A water filter composed of zirconia which has been molded into a desired shape from zirconia powder mixed with 10% to 30% binder material.

27. A method of regenerating a filtration media composed of zirconia which comprises flowing a 5% sodium hydroxide fluid through it for a sufficient period of time for the removal of ions from the filtration media.

28. A filtration media for drinking water at point-of-use which comprises in series alumina filtration media and zirconia filtration media, of respective percentage ratios of between about 4 to 1 and 1 to 1.

29. A filter for use in filtering drinking water at point-of-use which comprises, in series, first a filtration media composed of alumina, and second a filtration media composed of zirconia.

30. The use of zirconia as a filtration media to remove arsenic from drinking water.

31. A filtration media for the removal of heavy metals and organic substances in drinking water which is composed of silica gel (60 Angstroms), aluminosilicate and activated carbon.

32. A filtration media to reduce chloroform and VOC from drinking water which comprises a mixture of silica gel (60 Angstroms) and carbon block which was made from coconut shell.

33. A filtration media which is composed of about 7% zirconia, 7% silica gel (60 Angstroms), 7% aluminosilicate and about 79% activated carbon.

34. A filtration media which is composed of about 20% silica gel (60 Angstroms) and about 80% activated carbon.

35. A filtration media which is composed of about 15% silica gel (60 Angstroms), about 15% aluminosilicate and about 70% activated carbon.

36. A filtration media which is composed of about 70% activated carbon, about 10% aluminosilicate, about 10% zirconia and about 10% silica gel (60 Angstroms), said activated carbon being coated with said aluminosilicate, zirconia and silica gel (60 Angstroms).

37. A filtration media which is contained in volumes from 5 cubic inches to 3,000 cubic inches and which is composed of a mixture of zirconia, silica gel (60 Angstroms) and carbon block.

38. A filtration media which is composed of a mixture of silica gel (60 Angstroms) and activated carbon, wherein said silica gel (60 Angstroms) is coated on granulars of said activated carbon.

39. A filtration media for removing arsenic, chloroform and fluorides from drinking water which is composed of zirconia in granular form.

40. A filtration apparatus comprising a gravity column having a first stage which contains a filtration media composed of alumina (gamma, acid washed) and a second stage containing a filtration media composed of zirconia.

41. A filtration media comprising a mixture of zirconia and granular or powdered activated carbon.
